(19) United States
(12) Patent Application Publication
(10) Pub. No.: US 2020/0114425 A1
(43) Pub. Date: Apr. 16, 2020

(54) SUCTION DEVICE FOR ADDITIVE PRODUCTION

(71) Applicant: Siemens Aktiengesellschaft, Munich (DE)

(72) Inventors: Michael Ott, Mulheim an der Ruhr (DE); David Rule, Hamburg (DE)

(73) Assignee: Siemens Aktiengesellschaft, Munich (DE)

(21) Appl. No.: 16/619,640

(22) PCT Filed: Jun. 4, 2018
(86) PCT No.: PCT/EP2018/064566

§ 371 Date: Dec. 5, 2019

(30) Foreign Application Priority Data
Jun. 26, 2017 (DE) 10 2017 210 718.9

(51) Int. Cl. B22F 3/105; B33Y 10/00

(52) U.S. Cl. CPC B22F 3/1055; B33Y 30/00; B33Y 10/00

(57) ABSTRACT

A device for guiding a protective gas over a powder bed for the purpose of additive production. The device includes a gas inlet for introducing the protective gas to the powder bed and a stationary gas outlet for removing the protective gas, wherein the device is furthermore designed to guide the protective gas over the powder bed in a laminar manner, and wherein the device furthermore has an outlet opening, configured parallel to a powder bed plane, for suctioning the protective gas out of a construction chamber during additive production of a component. A method for guiding a protective gas flow over a powder bed for the purpose of additive production is provided.

### CROSS REFERENCE TO RELATED APPLICATIONS

This application is the US National Stage of International Application No. PCT/EP2018/064566 filed 4 Jun. 2018, and claims the benefit thereof. The International Application claims the benefit of German Application No. DE 10 2017 210 718.9 filed 26 Jun. 2017. All of the applications are incorporated by reference herein in their entirety.

### FIELD OF INVENTION

The present invention relates to a device for guiding a protective gas over a powder bed for the additive manufacture of a component, or for correspondingly removing the protective gas by suction from a build chamber. A method for guiding a protective gas flow is further provided.

The component is advantageously intended for use in a turbomachine, advantageously in the hot gas path of a gas turbine. The component advantageously consists of a nickel-based or superalloy, in particular a nickel- or cobalt-based superalloy. The alloy can be precipitation-hardened or capable of being precipitation-hardened.

### BACKGROUND OF INVENTION

Generative or additive manufacturing processes include, for example, as powder bed processes, selective laser melting (SLM) or laser sintering (SLS), or electron beam melting (EBM).

A method for selective laser melting is known, for example, from EP 2 601 006 B1.

Additive manufacturing processes have been found to be particularly advantageous for complex components or components with a complicated or delicate design, for example labyrinthine structures, cooling structures and/or lightweight structures. In particular, additive manufacturing is advantageous because of a particularly short chain of process steps, since a production or manufacturing step of a component can take place directly on the basis of a corresponding CAD file.

Additive manufacturing is further particularly advantageous for the development or production of prototypes which, for example for cost reasons, cannot be produced, or cannot be produced efficiently, by means of conventional subtractive or machining methods or casting technology.

The metallurgical quality of a product produced by means of SLM is highly dependent on how well products that form inter alia during welding can be transported from the region of the melt pool. It is particularly important to remove in particular weld spatters and fumes from the melt pool and/or from the corresponding region of the powder bed. For this purpose, system manufacturers have provided a laminar gas flow (protective gas flow) over the powder bed or over the production surface in the build chamber of the system.

The gas flow further makes it possible to keep oxygen away from a gas environment of the melt pool and thus largely prevent oxidation or corrosion of the components.

Despite the protective gas flow, the component can be greatly contaminated by fumes, depending on the position on the build platform. This becomes all the more critical, the greater the chosen layer thickness of the powder layers that are to be applied because, as the layer thickness increases, higher laser energy is also required, and weld spatters and fumes can thus increasingly occur.

The mentioned gas flow is advantageously in laminar form, wherein a gas inlet and/or a gas outlet, either with a continuous gas opening or with a plurality of gas openings arranged in a row, can be in the form of a bar.

### SUMMARY OF INVENTION

It is an object of the present invention to provide means which permit improved discharge or removal by suction of fumes and/or other gas. There is a need for improved discharge of fumes in particular because there is a recognizable trend towards greater layer thicknesses in order to increase process efficiency in powder-bed-based additive manufacturing. By means of the present solution there can be developed, in addition to an increased suction power, advantageously also a protective gas flow adapted to individual irradiation conditions.

This object is achieved by the subject-matter of the independent patent claims. Advantageous embodiments are the subject-matter of the dependent patent claims.

One aspect of the present invention relates to a device for guiding a protective gas over a powder bed or for removing a protective gas by suction from a build chamber during the additive manufacture of a component. The device advantageously comprises a gas inlet for introducing the protective gas onto the powder bed and a stationary gas outlet for removing the protective gas, for example from the build chamber.

The device is further configured to guide the protective gas in a laminar manner over the powder bed, wherein the device for removing the protective gas by suction from the build chamber during the additive manufacture of the component comprises an outlet opening which is configured to be movable and/or controllable parallel to a powder bed plane.

The term “fumes” can refer in the present case to melt or combustion products, weld spatters or other substances which influence the metallurgical quality of the components to be produced. A protective gas which has been removed by suction or removed from the build chamber and which contains the fumes can be an aerosol.

As indicated above, the described device offers the advantage of ensuring the discharge of laminar protective gas in additive manufacturing advantageously over the entire build chamber or the entire powder bed and/or at the same time of adapting the removal by suction to the irradiation conditions, for example the laser power. In other words, intelligent or adapted discharge of fumes, in particular for large powder layer thicknesses, can be provided in the SLM or EBM process.

In one embodiment, the movable outlet opening can be moved relative to the powder bed, and advantageously parallel thereto, that is to say in the XY direction, via a controller.

In one embodiment, a movement of the outlet opening perpendicularly to a guiding direction or flow direction of the protective gas during the additive manufacture is coupled, or synchronized, with a movement of an energy beam for solidifying powder during the additive manufacture. By means of this embodiment, a protective gas discharge during the manufacturing process can be adapted particularly advantageously to the fumes formed by the solidification by means of the energy beam.

In one embodiment, a suction power for removing the protective gas by suction through the (movable) outlet opening is adjusted or adapted to a layer thickness of the corresponding powder layer for the or during the additive manufacture of the component. As the layer thickness increases, the suction power of the device, for example, that is to say, for example, the volume flow removed by suction per unit length or unit area, can also be increased, wherein, however, laminarity of the flow is advantageously retained.

In one embodiment, the stationary gas outlet is part of a suction bar. The bar can comprise a strip-like outlet opening or a plurality of individual outlet openings or slots arranged in a row.

In one embodiment, the movable outlet opening is integrated into the suction bar.

In one embodiment, a flow rate, that is to say, for example, a volume flow, of the protective gas to be removed by suction through the movable outlet opening during the additive manufacture, for example considered over the length of the outlet opening, is greater than a flow rate of the protective gas correspondingly to be removed through the stationary gas outlet. By means of this embodiment, an intelligent and/or adapted discharge of fumes can be ensured particularly simply locally, that is to say advantageously at the lateral position of the powder bed that is currently exposed by the laser beam or the energy beam.

In one embodiment, the device comprises a movable inlet nozzle which is coupled or synchronized with the movement of the outlet opening and/or with the movement of the energy beam via a controller.

In one embodiment, the device represents an upgrade kit for manufacturing systems for the additive manufacture of components.

One aspect of the present invention relates to a method for guiding a protective gas flow over the powder bed such that the protective gas moves in a laminar manner over the powder bed during the additive manufacture and protects the powder bed, for example comprising a melt pool, from harmful influences, for example corrosion, oxidation or mechanical influences resulting from the welding, such as weld spatters, wherein a volume or mass flow of the protective gas flow is locally adapted, in regions in which the powder bed is exposed to an energy beam, to a radiation power.

In the present case, the radiation power is advantageously dependent, for example proportionally dependent, on the layer thickness, since thicker layers to be melted require more energy for solidification.

Further details of the invention will be described hereinbelow with reference to the figures.

### BRIEF DESCRIPTION OF THE DRAWINGS

FIG. 1 shows a schematic perspective view of a device according to the invention.

### DETAILED DESCRIPTION OF INVENTION

In the exemplary embodiments and in the FIGURE, elements which are the same or have the same effect can in each case be provided with the same reference numerals. The elements shown and their relative proportions are generally not to be regarded as being true to scale; instead, for the purposes of better clarity and/or better understanding, individual elements can be shown with excessively thick or large dimensions.

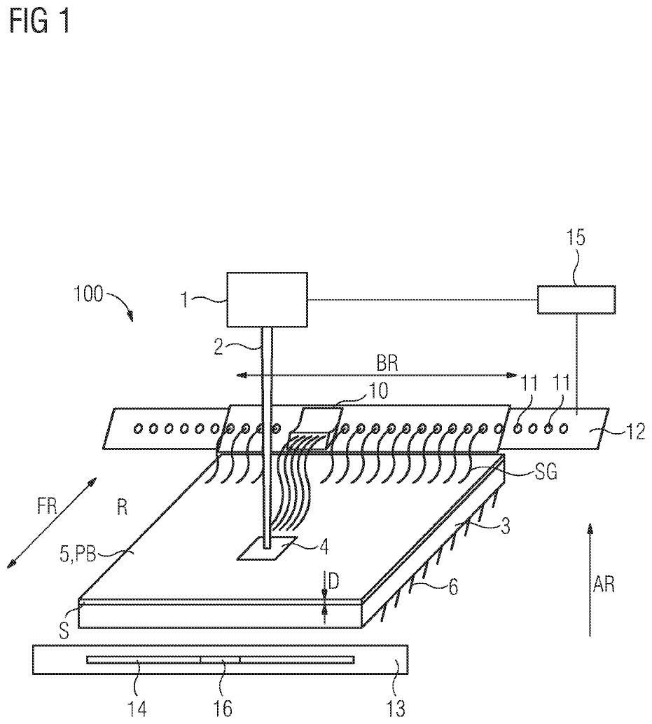

FIG. 1 shows a device 100 for guiding or removing by suction a protective gas SG in additive manufacturing. Some parts of the representation of FIG. 1 are explicitly not part of the device 100. In particular, there is shown in FIG. 1 a component 3 over which a layer S for the solidification of further component material is arranged. Such a coating is usually carried out by means of a coater (not explicitly identified). In accordance with its predetermined geometry, the powder layer, or a powder bed PB which consists of a powder 5, is irradiated at the corresponding positions with an energy beam 2. The energy beam can refer to a laser or electron beam and can be guided or scanned over the powder bed PB, for example by means of a scanner 1 or a corresponding optical system. During the irradiation, a melt pool 4 forms locally, that is to say where the focused energy beam 2 strikes the powder bed PB, as a result of the energy input. This melting and/or welding operation can further lead to the occurrence of fumes, weld spatters or other undesirable effects.

The component 3 is advantageously arranged on a build platform 6 or coherently “welded” or bonded thereto during the manufacturing material.

The process can be, for example, selective laser melting or electron beam melting. In particular, owing to the high laser or electron beam powers that are involved, which are necessary to locally melt and, as described, weld the material, fumes or weld spatters occur, which must be removed from the region of the powder bed by a laminar protective gas flow, for example. The (laminar) protective gas flow is in the present case indicated by the wavy pattern in the top region of FIG. 1.

The protective gas SG is advantageously guided over the powder bed in a guiding direction FR. Above the powder bed there is arranged a build chamber R for the component.

The device 100 comprises an inlet bar 13 for admitting protective gas SG into the build chamber R. The inlet bar 13 comprises a gas inlet which advantageously extends over at least one edge of the component and/or of the powder bed. Other than shown, the gas inlet can comprise—instead of an elongate inlet opening—a plurality of round or point-like inlet openings.

The device 100 further comprises a suction bar or stationary gas outlet 12 for removing by suction the protective gas containing the fumes or the impurities. The stationary gas outlet comprises a plurality of individual outlet openings 11. These outlet openings 11 are arranged in a row parallel to the powder bed PB and slightly above it.

The present invention provides that the device comprises a movable outlet opening 10. In the present case, the movable outlet opening 10 is advantageously integrated into the described stationary gas outlet and is adapted to be movable in a movement direction BR. When the movable outlet opening 10 is moved in the movement direction, a portion of the suction bar or of the outlet openings 11, corresponding to the length of the movable outlet opening 10, is locally replaced, for example as a result of a corresponding valve design, so that a correspondingly increased throughput or suction effect can also be achieved locally.

The movement direction is advantageously oriented perpendicularly to the guiding direction FR.

The movement direction BR and the guiding direction FR can both denote lateral directions, for example the XY direction, that is to say, for example, directions perpendicular to a build direction AR for the component 3.

In the present case, the movement of the outlet opening BR during the additive manufacture of the component 3 is coupled or synchronized with a movement of the energy beam 2 for powder solidification.

The movable outlet opening 10 is advantageously so integrated into the stationary gas outlet 12 that increased removal of gas by suction can thereby take place locally, as indicated by the longer waves of the protective gas at the level of the laser beam 2 in FIG. 1. The advantages of the invention can thereby be implemented. In other words, the movable outlet opening 10 can be guided in the movement direction exactly simultaneously with the movement component of the laser in the movement direction BR. Alternatively, according to the geometry or contour of the component, which could bring about a deflection of the protective gas flow, the movement of the movable outlet opening 10 could be made to correspondingly follow or be correspondingly in advance of that of the laser beam 2 (or vice versa).

A flow rate of the protective gas SG to be removed by suction through the movable outlet opening 10 during the additive manufacture can—when considered over a length of the movable outlet opening 10 considered in the movement direction BR—be greater than a flow rate of the protective gas SG correspondingly to be removed through the stationary gas outlet.

In the present case, a suction power for removing by suction the protective gas SG through the outlet opening 10 can further be adapted and/or adjusted to a layer thickness D of a powder layer S. This is advantageous in particular because the welding or solidification of large layer thicknesses, for example layer thicknesses of over 60 μm, in the additive processes requires comparatively high radiation powers, and thus more fumes and weld spatters also increasingly occur.

Analogously to this movement of the movable outlet opening coupled with the laser beam 2, for example via a controller 15, with the laser beam 2 in the movement direction BR, a movable inlet nozzle 16 can be provided inside in the gas inlet 14, so that an increased and/or locally adapted gas inflow—advantageously synchronized with the laser beam—can also take place.

The mentioned means are advantageously so adapted and dimensioned that the protective gas flow overall is laminar and can thus advantageously be used for discharging fumes and as oxidation protection for the component 3.

In other words, a method for guiding a protective gas flow over a powder bed PB is provided, such that the protective gas SG moves in a laminar manner over the powder bed PB during the additive manufacture and protects the powder bed, in particular a melt pool 4 of the powder bed PB, from damaging influences, for example fumes, weld spatters, corrosion and/or oxidation, wherein a volume flow or mass flow of the protective gas flow is locally adapted, in regions in which the powder bed PB is exposed to an energy beam 2, to a radiation power.

The invention is not limited by the description on the basis of the exemplary embodiments to the exemplary embodiments but includes any novel feature as well as any combination of features. This includes in particular any combination of features in the patent claims, even if that feature or that combination is itself not explicitly indicated in the patent claims or exemplary embodiments.

1.-9. (canceled)

10. A device for guiding a protective gas over a powder bed in additive manufacturing, comprising:
a gas inlet for introducing the protective gas onto the powder bed, and
a stationary gas outlet for removing the protective gas,
wherein the device is further configured to guide the protective gas over the powder bed in a laminar manner,
an outlet opening adapted to be movable parallel to a powder bed plane for removing the protective gas by suction from a build chamber during the additive manufacture of a component,
wherein the stationary gas outlet is part of a suction bar, and
wherein the movable outlet opening is integrated into the suction bar.

11. The device as claimed in claim 10,
wherein the outlet opening is moveable relative to the powder bed via a controller.

12. The device as claimed in claim 11,
wherein a movement of the outlet opening perpendicular to a guiding direction of the protective gas during the additive manufacture is coupled with a movement of an energy beam for solidifying powder during the additive manufacture.

13. The device as claimed in claim 12,
wherein a suction power for removing the protective gas by suction through the outlet opening is adapted to a layer thickness of a powder layer.

14. The device as claimed in claim 10,
wherein a flow rate of the protective gas to be removed by suction through the movable outlet opening during the additive manufacture, when considered over the length of the outlet opening, is greater than a flow rate of the protective gas correspondingly to be removed through the stationary gas outlet.

15. The device as claimed in claim 10, further comprising:
a movable inlet nozzle which is coupled to the movement of the outlet opening via a controller.

16. The device as claimed in claim 10,
wherein the device comprises an upgrade kit for manufacturing systems for the additive manufacture of the component.

17. A method for guiding a protective gas flow over a powder bed for additive manufacture, comprising:
moving a protective gas in a laminar manner over the powder bed during the additive manufacture and protecting the powder bed from harmful influences, and
locally adapting a volume flow of the protective gas flow, in regions in which the powder bed is exposed to an energy beam, to a radiation power.
